(19) United States
(12) Patent Application Publication
(10) Pub. No.: US 2002/0059990 A1
(43) Pub. Date: May 23, 2002

(54) Non-woven web having unique liquid resistance and dimensional stability

(76) Inventors: Philip Bush, Laurel, MS (US); Ricky Burkeen, Collinsville, MS (US); Robert H. Blanpied, Meridian, MS (US)

Correspondence Address: NIXON & VANDERHYE P.C., 8th Floor, 1100 North Glebe Road, Arlington, VA, 22201, US

(21) Appl. No.: 09/971,771

(22) Filed: Oct. 9, 2001

Related U.S. Application Data
(60) Provisional application No. 60/238,457, filed on Oct. 10, 2000.

(51) Int. Cl. D21H 11/14; D21B 1/32; D21C 5/02; D21H 13/40; C03B 37/00

(52) U.S. Cl. 162/3; 162/4; 162/7

(57) ABSTRACT

A non-woven web such as a facer comprises recycled cellulose fiber; recycled glass fiber, and, a sizing agent which provides the mat with decreased liquid penetrability over time. An example suitable sizing agent is alkenyl succinic anhydride (ASA) which has a dry basis add-on rate of from about 0.15% to about 0.4%, and preferably a dry basis add-on rate of from about 0.2% to about 0.3%. The sizing agent provides the mat with decreased liquid penetrability four weeks after mat production. In one aspect of the invention, the mats/facers can be employed as a facer for a rigid cellular foam board.

### BACKGROUND

This application claims the priority and benefit of United States Provisional Patent Application Serial No. 60/238,457, filed Oct. 10, 2000, which is incorporated by reference herein in its entirety.

### FIELD OF THE INVENTION

The present invention pertains to moisture resistant and dimensionally stable non-woven continuous webs such as facers, for example, and particularly relates to methods of sizing such webs against moisture and organic solvent penetration.

### RELATED ART AND OTHER CONSIDERATIONS

Non-woven continuous web materials have been known in the art at least since the 19th Century, when the English papermaking brothers Sealy and Henry Fourdrinier started their first machine. Over the years many fibers have been used to make various types of webs, including asbestos, bagasse, cotton, glass, hemp, jute, kenaf, sisal, various types of wood cellulose pulp, and many forms of synthetic plastic fibers. For example, U.S. Pat. Nos. 3,773,513 and 3,885,962 to MacClaren teach the use of glass fiber and latex to stabilize a photographic paper.

When health concerns made asbestos fiber obsolete, web makers turned to glass fibers and synthetic fibers made of various plastics. For example, common vinyl floor backing webs which had been made with asbestos fibers were subsequently made of a combination of glass and plastic fibers using a polymer latex as a binder. U.S. Pat. Nos. 4,274,916 and 4,373,992 both disclose a dimensionally stable backing web using polypropylene fibers for stabilization. U.S. Pat. No. 4,373,992 further teaches the adding of glass fibers. U.S. Pat. No. 4,269,657 pertains to an asbestos-free web that uses slightly refined virgin cellulose fiber incorporating a low percentage of glass fiber.

A sampling of prior art directed toward various different types of fibers used in non-woven webs can be found in the following list of U.S. Pat. Nos, all of which are incorporated herein by reference:

U.S. Pat. Nos. 3,773,513 3,885,962 4,174,415 4,188,355 4,245,689 4,269,657 4,274,916 4,373,992 4,426,470 4,445,972 4,457,785 4,472,243 4,481,075 4,510,019 4,513,045 4,536,447 4,543,158 4,545,854 4,591,412 4,609,431 4,618,401 4,626,289 4,680,223 4,681,658 4,749,444 4,789,430 4,956,049 4,964,954 4,969,975 5,236,757 5,236,778 5,393,379 5,409,574 5,501,771 5,501,774 5,536,370

The art of “sizing” non-woven webs is nearly as old as the continuous formation mode. Used in this context, Webster defines “size” as “any thin, pasty, or gluey substance used as a glaze or filler on porous materials, as on plaster, paper, or cloth.” For the purpose of describing this invention, “to size” means to add a substance which imparts a certain degree of resistance to liquid penetration and absorption. In this regard, the liquid for which protection against penetration is sought can be any water-based material or any organic solvent. As an early example, the use of starch as an internal or surface additive is at least a century old. More recently, the same rosin that is extracted from wood cellulose papermaking fibers was modified and put to use as a sizing agent. Since then, the art of imparting liquid resistance to paper has become scientifically complex. In the late 1950s, Hercules, Incorporated sold an alkyl ketene dimer (AKD) in emulsion form to size paper without the use of alum with its detrimentally low pH. More recently, many companies offer alkenyl succinic anhydride (ASA) sizing agents.

A representation of prior art directed toward various different types of sizing agents and systems used in non-woven webs can be found in the following list of U.S. Pat. Nos, all of which are incorporated herein by reference:

U.S. Pat. Nos. 3,615,795 3,630,830 3,755,070 3,755,071 3,772,143 3,821,069 3,853,609 3,899,389 3,900,335 3,906,142 3,923,745 3,957,574 3,990,939 4,029,885 4,040,900 4,065,349 4,141,750 4,207,142 4,222,820 4,240,935 4,295,930 4,333,795 4,381,367 4,422,879 4,437,894 4,483,744 4,505,778 4,514,229 4,517,052 4,547,265 4,551,200 4,551,201 4,576,680 4,606,773 4,616,061 4,657,946 4,670,100 4,839,415 5,114,538 5,116,924 5,145,522 5,190,584 5,192,363 5,246,491 5,266,165 5,290,849 5,308,441 5,314,721 5,320,712 5,393,337 5,407,537 5,438,087 5,498,648 5,709,776 5,759,249 5,876,562 5,954,921 5,961,708 5,969,011 5,972,094 6,001,166 6,042,691 6,087,457 6,093,217

A particular non-woven continuous web material known as “felt” has been used for many years in the production of polyisocyanurate (polyiso) foam board insulation. This rigid plastic foam insulation board has become the most popular type of commercial roofing insulation. It is manufactured by pouring liquid chemical streams on the continuously moving bottom felt, known as the bottom “facer,” with a second facer being placed on top of the foaming streams. The polyiso foaming liquid is deposited between two webs of the facer felt, cured into a unified foamed board, and then cut into insulation board lengths. The largest producer of this facer felt, Atlas Roofing Corporation, developed a glass fiber-utilizing facer which Atlas refers to as “Glass Reinforced Felt” (GRF) Facer. Certain aspects of this facer product are disclosed in U.S. patent application Ser. No. 09/425,051. The GRF Facer has a higher degree of dimensional stability than 100% cellulose felt. As an integral part of an insulation board, GRF Facer adds strength and durability to a lightweight insulation board that is used in a severe environment. Strength and durability are important because commercial roofing products suffer some of the most intense punishment experienced by building construction products.

Historically, roofing felt and GRF Facers have primarily used nothing but recycled cellulose fiber as the majority furnish. In most cases, OCC (Old Corrugated Container) is the main source of fiber. In addition, mixed waste, or office waste, or newsprint, or wood flour, or some mixture of these has been the lower cost cellulose fiber source to augment the OCC. The successful use of recycled glass fiber has improved the properties of the facer web while keeping the cost reasonable. The cost of either virgin glass fiber or virgin cellulose fiber is much too high for this facer.

In the past, GRF Facers have been sized against moisture absorption. While the installation instructions that accompany the product are very clear that polyiso foam insulation boards should not get wet, they often do. If the top facer gets wet, and then is dried by hot sunshine, it can shrink, causing the insulation board to warp. An insulation board that is not completely flat is not suitable for a commercial roof. Thus an extremely important aspect of GRF Facer is the moisture resistance imparted by sizing.

However, in addition to moisture resistance, there is a need for a facer to also resist the penetration of the organic liquid mix that becomes the polyiso foam. At the current time, this organic liquid mix can contain either, or both, the blowing agents comprised of pentane isomers and HCFC-141b. These liquids are strong solvents that slowly penetrate the facer. At best, this penetration accounts for a substantial loss of expensive chemicals, and at worst, the liquid penetration can transport polyiso liquid completely through the facer onto the metal machinery that manufactures the product. The liquid coming into contact with the metal surface of the machinery is sticky and can glue the polyiso board to the machinery to the extent it shuts the manufacturing line down. Many hours of labor follow these shutdowns, in order to clean the metal surface before the machine can be started again.

Heretofore, some facers did not have sufficient resistance to the organic liquid used in manufacturing, even if the facer passed the QC Testing required for this purpose. Apparently, the sizing imparted to the prior art facer was not stable; i.e., the sizing would decrease over time. Also, while the sizing resistance to water might remain stable, the resistance to the organic liquid could decrease. Even large increases in the amount of rosin sizing does not help in many cases.

Thus, there remains a need for a facer that can be made economically while maintaining the original penetration resistance to both water and organic solvents over any length of time. Therefore it is an object of the present invention to provide an economical glass reinforced felt facer that has a high level of liquid penetration resistance to both water and organic solvents.

A further object of the invention is a facer that retains over time that high level of liquid penetration resistance.

### BRIEF SUMMARY OF THE INVENTION

A non-woven web such as a facer comprises recycled cellulose fiber; recycled glass fiber, and, a sizing agent which provides the mat with decreased liquid penetrability over time. An example suitable sizing agent is alkenyl succinic anhydride (ASA) which has a dry basis add-on rate of from about 0.15% to about 0.4%, and preferably a dry basis add-on rate of from about 0.2% to about 0.3%. The sizing agent provides the mat with decreased liquid penetrability four weeks after mat production. In one aspect of the invention, the mats/facers can be employed as a facer for a rigid cellular foam board.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view showing apparatus and process steps for producing a non-woven continuous web in accordance with a first example embodiment of the present invention.

FIG. 2 is a schematic view showing example apparatus and process steps for producing a non-woven continuous web in accordance with the prior art.

FIG. 3 is a schematic view showing apparatus and process steps for producing a non-woven continuous glass reinforced web (e.g., facer) in accordance with another example embodiment of the present invention.

FIG. 4 is a schematic view showing apparatus and process steps for utilizing the glass reinforced facer of the invention in producing a polyiso foam board.

### DETAILED DESCRIPTION

In the following description, for purposes of explanation and not limitation, specific details are set forth such as particular compositions, processes, techniques, etc. in order to provide a thorough understanding of the present invention. However, it will be apparent to those skilled in the art that the present invention may be practiced in other embodiments that depart from these specific details. In other instances, detailed descriptions of well-known ingredients, steps, or operations are omitted so as not to obscure the description of the present invention with unnecessary detail.

A non-woven web such as a facer comprises recycled cellulose fiber; recycled glass fiber; and, a sizing agent which provides the mat with decreased liquid penetrability over time. An example suitable sizing agent is alkenyl succinic anhydride (ASA) which has a dry basis add-on rate of from about 0.15% to about 0.4%, and preferably a dry basis add-on rate of from about 0.2% to about 0.3%. The sizing agent provides the mat with decreased liquid penetrability four weeks after mat production. In one aspect of the invention, the mats/facers can be employed as a facer for a rigid cellular foam board.

For the purpose of describing this invention, the term “recycled cellulose fiber” means either (1) post-consumer recycled waste paper and cardboard, or (2) pre-consumer but post-industrial recycled waste paper and cardboard, which is obtained from factories, or a combination of (1) and (2). An example of pre-consumer but post-industrial recycled waste paper and cardboard is the side-trim and clippings that come from paper converters. The supply of post-consumer recycled paper and cardboard is the most significant source of cellulose fiber for the products of the instant invention.

For the purpose of describing this invention, the term “clarifier sludge” refers to the rejected solids obtained from the water cleaning and recycling systems in paper and pulp mills often called “clarifiers.”

For the purpose of describing this invention, the term “recycled glass fiber” is exemplified by the synthetic binder-impregnated waste material not usable by the producers of glass-fiber mats. Due to the synthetic binders that are added during the formation of glass mats, only a limited amount of waste glass mat can be recycled within the mat-forming process. Too much recycled binder interferes with the acceptable formation of glass fibers on a forming wire. Owing to the high expense of cleaning the binder from mat trimmings, or rejected mat, this material has instead been sent to landfill sites. But by selling this scrap glass mat and trimmings (e.g., recycled glass fiber) to GRF Facer manufacturers for facer production in accordance with the techniques of the present invention, the glass mat producers can avoid the added cost of paying for landfill. Moreover, the GRF Facer producer enjoys lower costs for glass fiber.

In general, there are two drawbacks to using recycled glass fiber. A first drawback is that, after the recycled glass fiber has been subjected to the intense mechanical energy needed to break up the mat (especially if the mat is in the form of a roll), most of the fibers are shorter than any virgin fibers commercially available. A second drawback is that, due to the much shorter fiber lengths, the first-pass retention is lower than if virgin fiber had been used. However, recycled glass fiber lengths in GRF Facers can range from less than 1-mm up to over 13-mm, due to the wide range of recycled glass fibers employed and the varied conditions found in preparing the glass fibers for use.

The non-woven web of the present invention is comprised of recycled cellulose fiber and recycled glass fiber, and optionally, clarifier sludge. The non-woven web also comprises chemical additives to enhance one of processing and final web performance.

### EXAMPLE 1

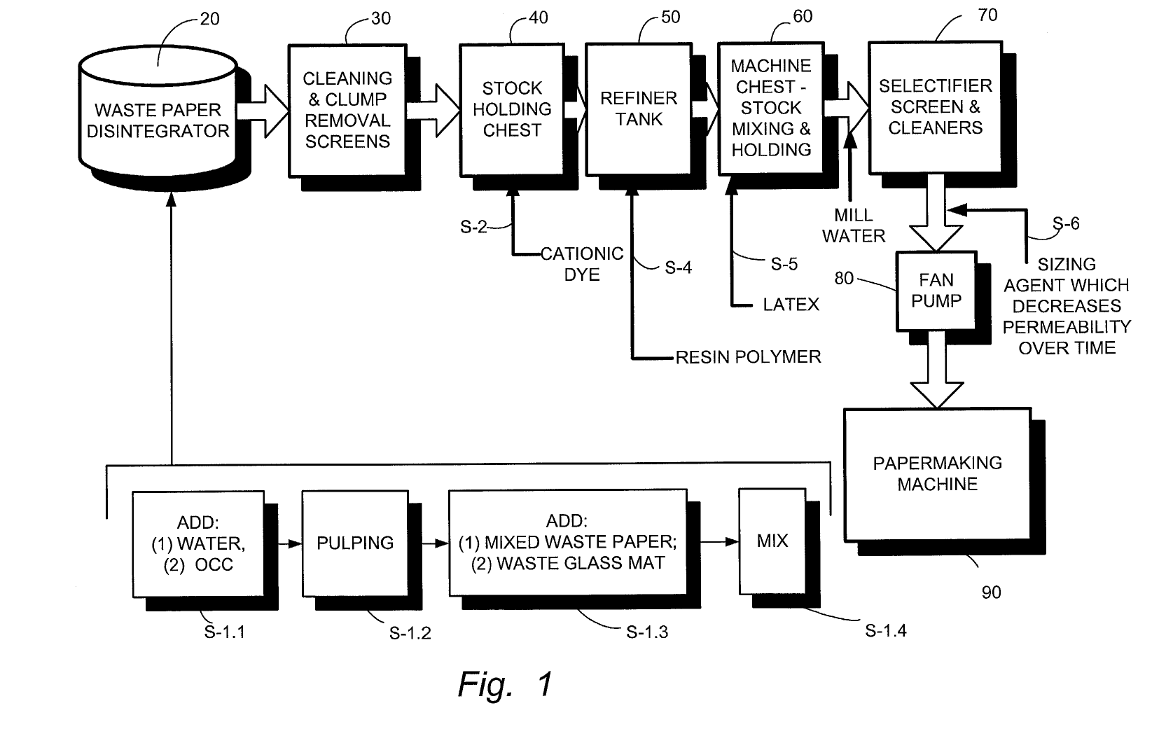

Basic structure and process steps involved in Example 1 are illustrated in FIG. 1, which shows an example sizing system of this invention. As step S-1.1, a large type waste paper disintegrator 20, as used by any waste-paper mill (such as a Hydrapulper® type waste paper disintegrator, for example), is charged with about 5000 gallons of water, to which is added about 1900 pounds of OCC (Old Corrugated Container). The water/OCC mixture is pulped (step S-1.2) until the big clumps are disintegrated. To the pulped mixture is added (as step S-1.3) about 650 pounds of Mixed Waste paper, another 5000 gallons of water, and 550 pounds of waste glass mat. The resulting stock is now at about 3.6% consistency (% solids).

As soon as this blend is well mixed (step S-1.4), it is passed through cleaning and clump removal screens 30. In a first stock chest 40, Basazol Black PR-376-L dye from BASF is added (as step S-2) in an amount sufficient to obtain the desired shade of gray, usually about four pounds of full strength dye per ton of GRF Facer. Dying or coloration as depicted by step S-2 is an optional step, as it should be understood neither dying, nor any particular choice of color, is required by nor critical to the present invention.

In the papermaking industry, chemical addition rates are normally measured in the liquid form, but reported using dry weight basis of the chemical per ton, or 2000 pounds, of finished paper. As an example, following the dye addition comes the addition of cationic resin polymer, such as a polyamide wet-strength agent. The liquid polymer is pumped into the system at a rate which will provide 30 dry pounds per ton of finished paper. Instead of reporting this as an add-on rate of 30 dry pounds per ton, this rate can be expressed as an add-on rate of about 1.5% dry basis (d.b.). The polymer is added to the thick stock (step S-4) in refiner tank 50. After passing through a stock refiner, the stock is pumped to a second holding chest 60 where about 3.5% d.b. anionically dispersed carboxylated SBR latex (step S-5) is added. Then the stock is diluted somewhat before passing through a Selectifier® screen and several cleaners 70.

Following the addition of latex and additional mill water (for dilution), a sizing agent is added as step S-6. In view of the utilization of recycled cellulose fiber and recycled glass fiber, the sizing agent (which reacts both with water and the cellulose) is chosen to have, under desired drying conditions, a fast reaction rate with cellulose and a propensity for a fairly complete reaction. Such choice of sizing agent promotes a higher degree of curing, e.g., formation of liquid resistant ingredients into a sheet in the papermaking machine.

One example of such a sizing agent is a cationic emulsion of Nalco's ASA (alkenyl succinic anhydride) added (step S-6) in the amount of 0.25% d.b. (dry basis) of the finished product. At this time it is not entirely known what other synthetic sizing agents can be used in place of ASA or in conjunction with ASA. Some internal synthetic sizing agents, such as Basoplast 265D [a styrene acrylate copolymer dispersion sold by BASF], may well work; but have a high initial cost. One other internal synthetic sizing agent, namely AKD (alkyl ketene dimer), was found to be unacceptable due to a loss of sizing over time.

Vendors of the foregoing synthetic sizing agents claim their products to be effective within a range of from about 0.1% to 1.0% dry basis add-on rates. It has been discovered that, for the present invention, a freshly prepared ASA sizing dispersion actually works well at the lower end of the recommended add-on rates. In the preferred embodiments of this invention, ASA is used in the range of from about 0.15% to about 0.4%, with the most preferred range being from about 0.2% to about 0.3% dry basis add-on rates.

The addition of sizing is followed by further stock dilution at a fan-pump 80 to about 0.8% consistency. All the active chemicals (e.g., the cationic dye, resin polymer, sizing agent(s), and SBR latex) are pumped to their respective addition points as full strength liquids, but then mixed with a stream of mill water to reduce the concentration. This dilution substantially aids in product distribution. The stock is then introduced to the paper making machine 90. Paper making machine 90 can comprise any suitable apparatus, such as a Fourdrinier, a single cylinder, or multiple cylinder vat machines, for example. After initial stock dilution, various processing aids such as retention aids, drainage aids, and defoamers may be added as needed in paper making machine 90. One example of such appropriate retention and drainage agents or aids involves utilizing an acrylamide modified cationic copolymer such as Nalco 7520 at about two pounds (2.0-lbs. as-received liquid basis) per ton of paper in conjunction with about one (1) pound (dry basis per ton) of a strongly anionic amorphous silica such as Nalco 8692. In paper making machine 90, the sheet formed is pressed by a standard mechanical paper wet-press section before introducing the web to a typical steam-heated dryer section.

The single cylinder vat machine web produced by Example 1 exhibits the test characteristics shown in Table 1. With regard to Tables 1, 2, and 3, all the tests are familiar to all persons skilled in the art of papermaking and/or are understood in the context of the present disclosure. In this regard, the Solvent of the Penetration Test is comprised of Stepan polyol S-2352 at 100-parts-by-weight (pbw) mixed with 30-pbw HCFC-141b. The polyol is obtained from Stepan Company, Northfield, Ill. 60093, and HCFC-141b can be obtained from Atochem or Aldrich. The Test is made by holding an elevated 12-inch square sample horizontal, dropping 10-grams of Solvent in the center, and recording the seconds required for the first small circle of “show-through” to appear. These test results represent the Quality Control Tests made within 24 hours of production.

TABLE 1

| CHARACTERISTIC/TEST | MEASUREMENT |
|---|---|
| Initial Solvent Penetration Test | 22-seconds to First Penetration |
| At 4-weeks Solvent Penetration Test | 37-seconds to First Penetration |
| Initial 2-minute Cobb Test | 5.0% weight increase from water absorption |
| At 4-weeks 2-minute Cobb Test | 4.8% weight increase from water absorption |
| Basis Weight | 24-pounds per 480-ft² |
| Tensile Test, M.D. | 35-pounds per linear inch (1″ by 8″ test strip) |
| Ash Content | 16% |

The test results of Example 1 show a slightly higher level of initial sizing from that of Example 2, in both the Penetration Test and the Cobb Test. However, a significant difference shows up when the web is re-tested for sizing after aging four (4) weeks at ambient warehouse conditions. Table 1, shows these test results. It is an extremely important feature for a manufacturer to know that the product they make will actually have better size-test results when the Facer is later used to make foam board.

### EXAMPLE 2

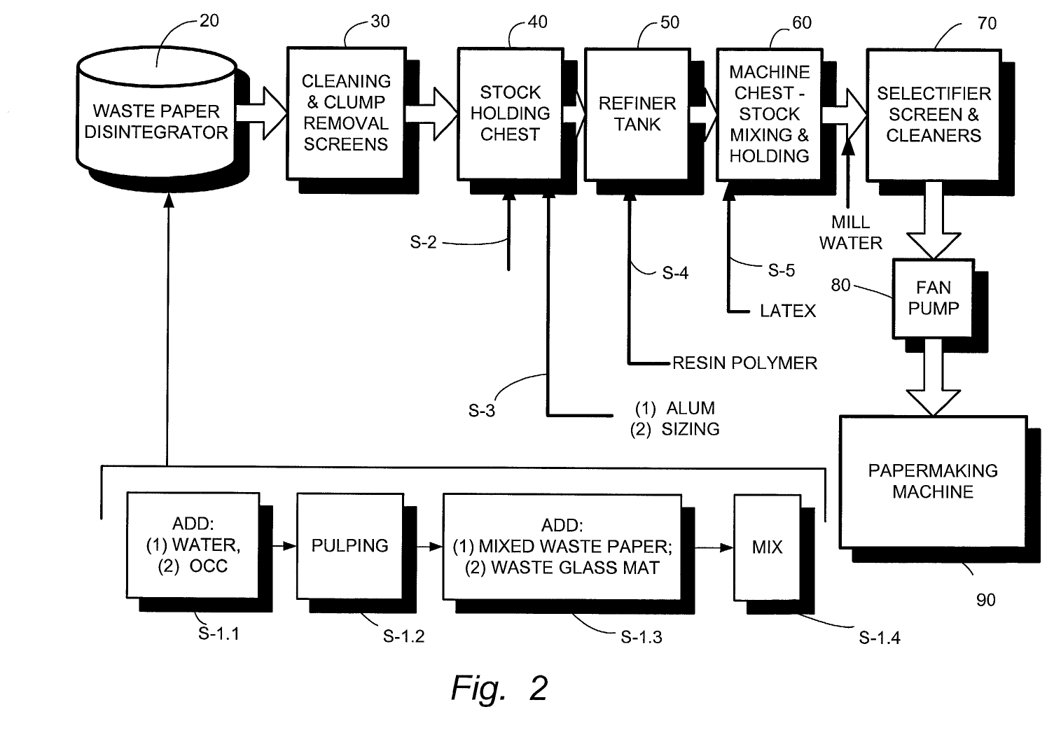

Basic structure and process steps involved in Example 2 are illustrated in FIG. 2. Example 2 involves the same equipment employed in Example 1, for which reason the equipment in FIG. 2 bears the same reference numbering as FIG. 1. Process steps that are similar in both FIG. 1 and FIG. 2 are also similarly numbered.

The same initial stock furnish as used in Example 1 is prepared for Example 2, e.g., steps S-1.1 through S-1.4 are performed. As step S-2, Basazol dye is added at the same 0.2% as-is basis. In Example 2, rosin size and alum are utilized (i.e., step S-3) as the prior art method of sizing. Specifically, the addition of 4.4% dry-basis (d.b.) alum, and 1.0% d.b. saponified rosin size, which (as indicated by step S-3) is added to stock holding chest 40. Any rosin-based size, such as dispersed rosin, can be used. After the sizing is added, about 1.5% d.b. cationic resin polymer, such as a polyamide wet-strength agent, is added to the thick stock (step S-4) in refiner tank 50. This is followed by the addition of a latex (step S-5), such as a carboxylated SBR.

The various processing aids of Example 1 are also employed in the paper making machine 90 for Example 2. The test results of Example 2 are shown in TABLE 2.

TABLE 2

| CHARACTERISTIC/TEST | MEASUREMENT |
|---|---|
| Basis Weight | 24-pounds per 480-ft² |
| Tensile Test, M.D. | 35-pounds per linear inch (1-inch by 8-inch test strip) |
| Ash Content | 15% |
| Organic Solvent Penetration Test | 13 seconds to 18 seconds to First Penetration |
| Two minute Cobb Test | 5.6% weight increase from water absorption |

As the sheet of Example 2 aged; e.g., 4 weeks after initial testing, it lost the acceptable sizing tests, specifically the Cobb Test. Table 3 shows the size tests for the sheet of Example 2 after 4 weeks of warehouse ambient conditions.

TABLE 3

| CHARACTERISTIC/TEST | MEASUREMENT |
|---|---|
| Organic Solvent Penetration Test | 10 seconds to 15 seconds to First Penetration |
| Two minute Cobb Test | 11.5% weight increase from water absorption |

Other prior art data have indicated the same general loss in sizing when using the AKD (Alkyl Ketene Dimer) sizing system.

### EXAMPLE 3

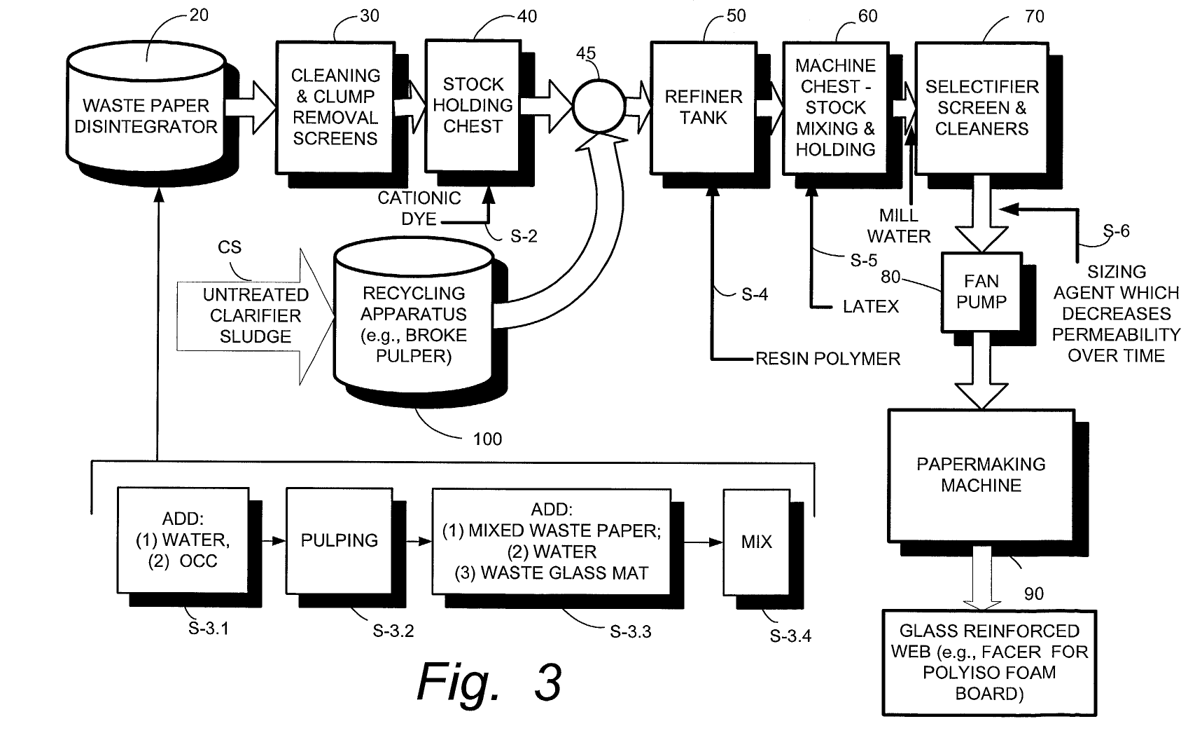

Example 3, illustrated by FIG. 3, shows a method of making a sized and dimensionally stable felt with cost savings introduced by the use of Untreated Clarifier Sludge. As step S-3.1, a large type waste paper disintegrator 20 is charged with about 5000 gallons of water, to which is added about 1450 pounds of OCC (Old Corrugated Container). After this is adequately mixed (step S-3.2), another 1200 gallons of water and about 550 pounds of waste glass mat are added (step S-3.3) and mixed (step S-3.4). This 3.72% consistency stock is passed through the Cleaning and Clump Removal Screens 30 into the Stock Holding Chest 40. Concurrently, Untreated Clarifier Sludge at from about 30% to about 45% total solids content (consistency) is introduced to Broke Pulper 100 and diluted with water to about 3.5% consistency. This material is pumped to a metering device 45 immediately above the Refiner Tank 50. From this point, the stock is treated in a like manner as Example 1 including steps S-2 through S-6. As step S-6, the preferred synthetic sizing agent is Alkenyl Succinic Anhydride, which is added at the rate of about 0.2% to about 0.4% dry basis weight.

Instead of adding cationic dye to Stock Holding Chest 40, the color of the sized felt can be modified by pigments that are added to the Machine Chest 60. As previously stated, it is not important to this invention to modify the color of the sized felt.

Example 3, which pertains to mats and facers of the present invention including clarifier sludge, is further described in U.S. patent application Ser. No. 60/238,420 and simultaneously-filed U.S. patent application Serial No. 09/___,___ (attorney docket 2334-195), both entitled “Non-Woven Web Made With Untreated Clarifier Sludge”, which are incorporated herein by reference in their entirety.

The web produced by Example 3 exhibits the test characteristics shown in Table 4. Again, if the percent Clarifier Sludge utilized is not excessive, there will be no loss of properties appearing. At worst, a 10% reduction in the tensile strength may be observed; however, that amount is not significant in this grade.

TABLE 4

| CHARACTERISTIC/TEST | MEASUREMENT |
|---|---|
| Basis Weight | 25-pounds per 480-ft² |
| Tensile Test, M.D. | 28-pounds per linear inch (1-inch by 8-inch test strip) |
| Ash Content | 17% |
| Organic Solvent Penetration Test | 14 seconds to 18 seconds to First Penetration |
| Two minute Cobb Test | 6.7% weight increase from water absorption |

### EXAMPLE 4

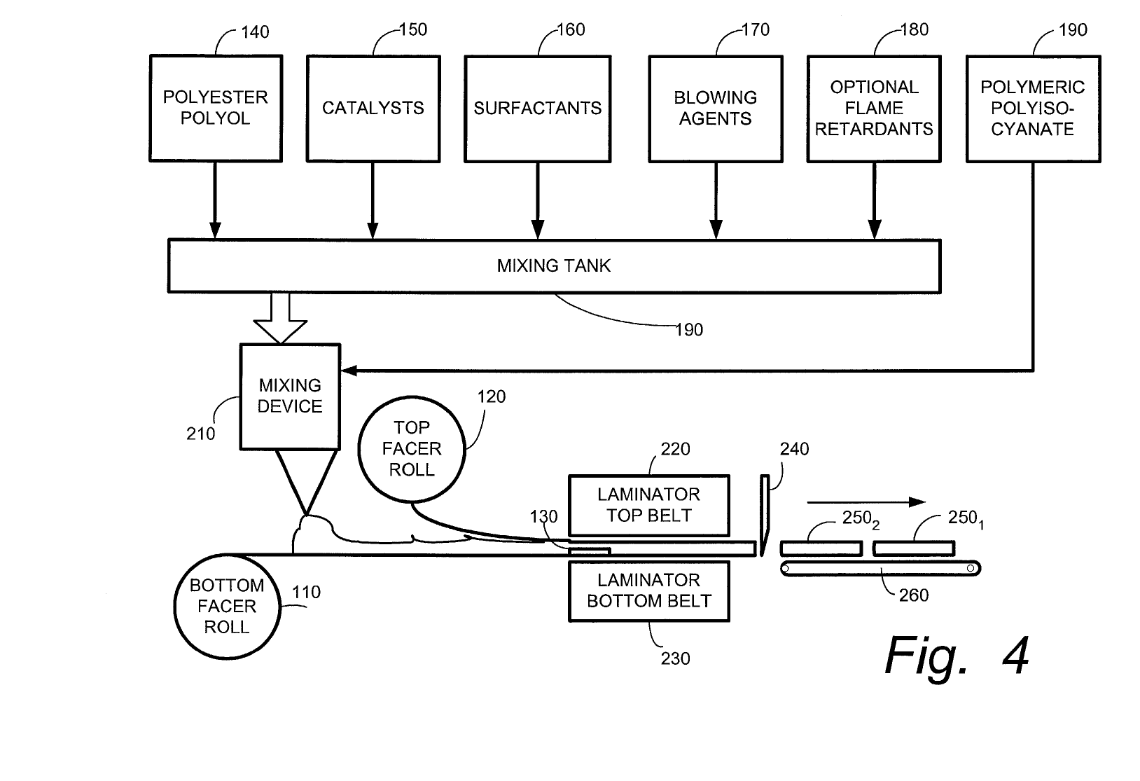

Another aspect of the present invention is a rigid cellular foam insulation board made with the lower cost GRF Facer material of the present invention, and method(s) of making the same. Such boards can be made on a typical continuous restrained-rise double steel belt foam board laminator, or on any other board producing machinery such as a continuous free-rise foam board machine. FIG. 4 shows a representative generic type restrained-rise laminator that can use facers of the present invention (e.g., the facers of Example 1). Basic structure and process steps involved in a foam board production are also illustrated in FIG. 4. While this illustrates a generic type restrained-rise laminator, it should be kept in mind that a free-rise machine may be employed.

Two (2) rolls 110 and 120 of GRF Facer of the invention are unwound and pulled into the laminator. On a free-rise machine, motor-driven pull-rolls grip the facers to provide the means to feed the machine, whereas on a restrained-rise machine, scrap boards 130 are used grip the two facers between the double belts. Prior to the machine starting, the bulk polyol in storage tank 140 is mixed with other chemicals such as catalysts, surfactants, blowing agents, and (optionally) flame retardants. These additives are stored as shown in storage tanks 150, 160, 170, and 180 respectively. The above mentioned chemicals from storage tanks 150, 160, 170, and 180 are completely mixed in mixing tank 190. As the machinery is started the polymeric polyisocyanate in storage tank 200 is pumped to the mixing device 210 at the same instant that the mixed materials in mixing tank 190 are fed to the mixing device 210. At this point, all the chemicals needed have been mixed and are laid on the bottom facer before the top facer is lowered into place on top of the chemicals. These mixed chemicals begin to react and expand in preplanned rates (see U.S. Pat. No. 5,252,625; U.S. Pat. No. 5,254,600; and U.S. Pat. No. 5,294,647; all incorporated herein by reference in their entirety). As the liquid turns into foam it expands to fill the cavity between the top laminator belt 220 and the bottom laminator belt 230, both motorized parts of the machine. A solid board is created and viewed for quality at the end of the laminator. A crosscut saw 240 cuts the solid boards 250₁ and 250₂ into planned lengths, which are then carried away from the crosscut saw 240 by a motorized conveyor 260 that runs faster than the laminator belts 220 and 230. The rigid boards are stacked and wrapped, completing the process.

Thus, for the mats and facers of the present invention, ASA (alkenyl succinic anhydride) sizing systems provide liquid penetration resistance at a comparable cost to other sizing methods. Usage of the ASA sizing agent for mats/facers formed with waste paper and clarifier sludge (considered by some to be the worst of all fiber furnishes), actually increased the sizing with age. Thus, not only was the problem of decreasing sizing levels solved, the GRF Facer made with ASA enjoys a slight increase in sizing levels over time.

Moreover, the present invention utilizes an ASA (alkenyl succinic anhydride) sizing system with waste glass (recycled glass fiber) and waste paper (recycled cellulose fiber). As a further benefit, the mats/facers of the present invention appear to achieve a slight increase in dimensional stability. Possibly due to a more even covering of sizing particles onto cellulose fiber, the ASA sized web does not expand as much when wet, and does not shrink as much when dried. Finished foam boards formed with the mats/facers of the present invention do not appear to warp as much as prior art boards.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

The embodiments of the invention in which an exclusive property or privilege is claimed are defined as follows:

What is claimed is:

1. A non-woven web comprising:
recycled cellulose fiber;
recycled glass fiber, and
a sizing agent which provides the mat with decreased liquid penetrability over time.

2. The apparatus of claim 1, wherein the sizing agent is alkenyl succinic anhydride.

3. The apparatus of claim 2, wherein the sizing agent has a dry basis add-on rate of from about 0.15 % to about 0.4%.

4. The apparatus of claim 2, wherein the sizing agent has a dry basis add-on rate of from about 0.2% to about 0.3%.

5. The apparatus of claim 1, wherein the sizing agent provides the mat with decreased liquid penetrability four weeks after mat production.

6. The apparatus of claim 1, further comprising untreated clarifier sludge.

7. The apparatus of claim 6, wherein the sizing agent is alkenyl succinic anhydride.

8. The apparatus of claim 7, wherein the sizing agent has a dry basis add-on rate of from about 0.15% to about 0.4%.

9. The apparatus of claim 7, wherein the sizing agent has a dry basis add-on rate of from about 0.2% to about 0.3%.

10. A non-woven web comprising:
recycled cellulose fiber;
recycled glass fiber, and
alkenyl succinic anhydride as a sizing agent.

11. The apparatus of claim 10, wherein the alkenyl succinic anhydride has a dry basis add-on rate of from about 0.15% to about 0.4%.

12. The apparatus of claim 10, wherein the alkenyl succinic anhydride has a dry basis add-on rate of from about 0.2% to about 0.3%.

13. The apparatus of claim 10, wherein the alkenyl succinic anhydride provides the mat with decreased liquid penetrability four weeks after mat production.

14. The apparatus of claim 10, further comprising untreated clarifier sludge.

15. The apparatus of claim 14, wherein the sizing agent has a dry basis add-on rate of from about 0.15% to about 0.4%.

16. The apparatus of claim 14, wherein the sizing agent has a dry basis add-on rate of from about 0.2% to about 0.3%.

17. A method of forming a non-woven web, the method comprising:
making a mixture of recycled cellulose fiber and recycled glass fiber;
adding a sizing agent to the mixture;
forming the mixture into a mat;
choosing the sizing agent to provides the mat with decreased liquid penetrability over time.

18. The method of claim 17, wherein the sizing agent is alkenyl succinic anhydride.

19. The method of claim 17, further comprising adding the sizing agent at a dry basis add-on rate of from about 0.15% to about 0.4%.

20. The method of claim 17, further comprising adding the sizing agent at a dry basis add-on rate of from about 0.2% to about 0.3%.

21. The method of claim 17, wherein the sizing agent provides the mat with decreased liquid penetrability four weeks after mat production.

22. The method of claim 17, further comprising adding untreated clarifier sludge to the mixture.

23. The method of claim 22, wherein the sizing agent is alkenyl succinic anhydride.

24. The method of claim 22, further comprising adding the sizing agent at a dry basis add-on rate of from about 0.15% to about 0.4%.

25. The method of claim 22, further comprising adding the sizing agent at a dry basis add-on rate of from about 0.2% to about 0.3%.

26. A rigid cellular foam board comprising:
a first facer and a second facer;
a rigid cellular foam formed between the first facer and the second facer;
wherein at least one of the first facer and the second facer comprise:
recycled cellulose fiber;
recycled glass fiber, and
a sizing agent which provides the facer with decreased liquid penetrability over time.

27. The apparatus of claim 26, wherein the sizing agent is alkenyl succinic anhydride.

28. The apparatus of claim 26, wherein the sizing agent has a dry basis add-on rate of from about 0.15% to about 0.4%.

29. The apparatus of claim 26, wherein the sizing agent has a dry basis add-on rate of from about 0.2% to about 0.3%.

30. The apparatus of claim 26, wherein the sizing agent provides the facer with decreased liquid penetrability four weeks after facer production.

31. The apparatus of claim 26, wherein the foam is a polyisocyanurate foam.

32. The apparatus of claim 26, wherein at least one of the first facer and the second facer further comprise untreated clarifier sludge.

33. The apparatus of claim 32, wherein the sizing agent is alkenyl succinic anhydride.

34. The apparatus of claim 32, wherein the sizing agent has a dry basis add-on rate of from about 0.15% to about 0.4%.

35. The apparatus of claim 32, wherein the sizing agent has a dry basis add-on rate of from about 0.2% to about 0.3%.
